(19) United States
(12) Patent Application Publication
(10) Pub. No.: US 2014/0360982 A1
(43) Pub. Date: Dec. 11, 2014

(54) SWITCHING DEVICE WHICH IS SUITABLE FOR DC OPERATION

(71) Applicants: Karsten Gerving, Bonn (DE); Volker Lang, Bonn (DE); Johannes Meissner, Bonn (DE); Ralf Thar, St. Augustin (DE)

(72) Inventors: Karsten Gerving, Bonn (DE); Volker Lang, Bonn (DE); Johannes Meissner, Bonn (DE); Ralf Thar, St. Augustin (DE)

(73) Assignee: EATON ELECTRICAL IP GMBH & CO. KG, Schoenefeld (DE)

(21) Appl. No.: 14/366,010

(22) PCT Filed: Dec. 12, 2012
(86) PCT No.: PCT/EP2012/075270

§ 371 Date: Jun. 17, 2014

(30) Foreign Application Priority Data
Dec. 22, 2011 (EP) 11195176.0

(51) Int. Cl. H01H 33/18; H01H 33/20; H01H 33/10

(52) U.S. Cl. CPC H01H 33/182; H01H 33/10; H01H 33/20
USPC 218/24

(57) ABSTRACT

A switching device suitable for DC operation includes at least one pair of contacts having a first contact and a second contact, wherein at least one of the two contacts is mobile and the two contacts are in contact with one another in a switched-on state of the switching device and are not in contact with one another in a switched-off state of the switching device, further having an arc driver arrangement for generating a magnetic field and an arc guiding arrangement for guiding an arc, which is produced between the contacts, to a quenching device. The problem of quenching arcs independently of the current direction in just one individual quenching apparatus in each case is solved with a substantially homogeneous magnetic field which is generated by permanent magnets.

### CROSS-REFERENCE TO RELATED APPLICATIONS

This application is a U.S. National Stage application under 35 U.S.C. §371 of International Application No. PCT/EP2012/075270, filed on Dec. 12, 2012, and claims benefit to European Patent Application No. 11 195 176.0, filed on Dec. 22, 2011. The International Application was published in German on Jun. 27, 2013, as WO 2013/092351 A1 under PCT Article 21(2).

### FIELD

The invention relates to a switching device suitable for direct current operation the switching device having at least one contact pair with a first contact and a second contact, where at least one of the two contacts is movable and both contacts are in contact with each other in a switched on state of the switching device and are not in contact in a switched off state of the switching device.

### BACKGROUND

A switching device for direct current applications uses a magnetic field with field lines running essentially transverse to the isolation gap of the current paths. One or more receiving areas are provided in one housing, each for one current path per pole, where each current path is assigned one movable switching contact element as well as, for example, two fixed switching contact elements opposite to each other. The three movable switching contact elements can be moved together, between a closed position which corresponds to the switched-on state of the switching device, and an open position which corresponds to a switched-off state of the switching device. The individual current paths are each assigned two arc extinguishing devices in the form of extinguishing plates, arranged over one another and electrically isolated from each other. In addition, when the movable switching contact elements are open, each current path has one or two isolation gaps which form between their ends and the first and second fixed switching contact elements which are allotted to these ends. On opening of the switching contact elements, an arc which can be extinguished with the help of arc extinguishing devices is formed along isolation gaps. Since arcs in direct current applications cannot be extinguished during zero current passing as in alternating current applications, a magnetic field that drives the arc into an arc extinguishing device has to be used in direct current applications. This magnetic field is built up for example by permanent magnets, a magnetic field being built up with field lines in an orientation which runs transverse to the isolation gaps and create a Lorenz force on the arcs that form along these separation sections which drives an arc in the direction of one of the arc extinguishing devices. In this context, an arc between a first contact pair is driven in the direction of a first arc extinguishing device and the arc between a second contact pair is driven in the direction of the second arc extinguishing device.

A switching device of this kind is known for example from EP 2 061 053 A2. Since the movement of the arcs is dependent on the direction of current flow, the switching device is only suitable for one current direction, i.e. polarity. If the switching device is operated with opposite polarity, the arcs will not be driven into the arc extinguishing devices, but rather in the opposite direction.

EP 0 473 013 A2 discloses a device for switching DC electrical power which is non-polarised or bi-directional, meaning that its power depends on the polarity of the current at the power connections, and can switch high-voltage DC power. For this purpose, a central arc extinguishing chamber and a pair of laterally separated arc extinguishing chambers are provided. Depending on the polarity, an arc is led either into the central arc extinguishing chamber or into the laterally separated arc extinguishing chambers.

DE 19 46 065 U relates to a polarity-dependent arc extinguishing device for DC switching devices wherein, with constant polarity, the arc always impinges on only one side of the arc chamber. If the arc chamber is turned 180° and replaced on the switching device, the direction of the magnetic field is thereby changed whereby, with the same current direction, the deviation direction of the arc is reversed, so that the arc chamber half not previously impinged on is used for extinction.

### SUMMARY

An aspect of the invention provides a switching device, suitable for direct current operation, the switching device comprising: a contact pair including a first contact and a second contact, at least the second contact being movable and the first contact being in contact with the second contact in a switched-on condition of the switching device and out of contact in a switched-off condition of the switching device; an arc driver assembly configured to generate a magnetic field; and an arc guide arrangement configured to guide an arc arising between the first contact and the second contact toward an extinguishing device, wherein the arc guide arrangement is subdivided into a first arc guide path and a second arc guide path, wherein the first arc guide path is configured to guide an arc arising between the first contact and the second contact with a first current direction, wherein the second arc guide path is configured to guide an arc arising between the first contact and the second contact with a second current direction opposite to the first current direction, and wherein the second arc guide path performs a reversal of the arc, the current, or the arc and the current. The arc is guided into a common extinguishing device regardless of the original current flow direction in the arc.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1, a partial perspective view of an embodiment of a switching device according to the invention;

FIG. 2, another embodiment of the switching device according to FIG. 1;

FIG. 3, a side view of the switching device according to FIG. 1;

FIG. 4, a side view of another embodiment of a switching device according to the invention;

FIG. 5, a partial perspective view of the embodiment of the switching device according to FIG. 4;

FIG. 6, another embodiment of the switching device according to FIG. 1; and

FIG. 7, an arc driver assembly with a permanent magnet and pole plates.

### DETAILED DESCRIPTION

An aspect of the present invention provides a switching device suitable for direct current operation, the switching device having at least one contact pair with a first contact and a second contact, where at least one of the two contacts is movable and both contacts are in contact with each other in a switched-on state of the switching device and are not in contact in a switched-off state of the switching device, further comprising an arc driver assembly for generating a magnetic field, and an arc guiding arrangement for guiding an arc arising between the contacts to an extinguishing device.

One aspect of the present invention provides a switching device which can be operated independently of polarity, which can therefore be used for different current directions, wherein in particular arcs that occur can be extinguished in only a single arc extinguishing device, regardless of the current direction.

An aspect of the invention provides a switching device suitable for direct current operation, has at least one contact pair with a first contact and a second contact, at least the second contact being movable and the first contact being in contact with one another in the switched-on state of the switching device and out of contact in a switched-off state of the switching device an arc driver assembly for generating a magnetic field being provided, particularly for generating a substantially homogeneous magnetic field using permanent magnets. An arc guiding assembly is provided for guiding an arc arising between the first contact and the second contact toward an extinguishing device. The arc guiding assembly is divided into a first arc driving path and a second arc driving path, the first arc driving path being provided for guiding an arc arising between the first contact and the second contact with a first current direction, and the second arc driving path for guiding an arc arising between the first contact and the second contact with a second current direction opposite to that of the first current direction, and the second arc driving path causing a reversal of the arc, so that the arc is guided to a common extinguishing device regardless of the original flow direction of the current in the arc.

Reversal of the arc in the sense of the invention comprises a change in the position of the arc relative to its surroundings, so that, given a homogeneous and constant magnetic field, a change in the force direction of the Lorentz force results due to the change in the position of the arc. In other words, each change in the position of the arc also means a change in the current flow direction relative to the homogeneous and unvarying magnetic field. Reversal of the arc is synonymous with a reversal of the current direction in the arc relative to the homogeneous and unvarying magnetic field. Due to the direction of the Lorentz force, which is thus also reversed, it is advantageously accomplished that each arc can always be guided into one and the same extinguishing device regardless of polarity. Control of the Lorentz force by changing the magnetic field is not an object of the invention. The common extinguishing device is provided for extinguishing arcs regardless of their original polarity. If all the arcs of a contact pair are guided into a common extinguishing device, this means, for the purpose of the invention, that the arcs reach the same location regardless of their original polarity. In a deionising extinguishing chamber with a plurality of extinguishing plates, this means that the arcs are broken up by the same extinguishing plates, usually by all extinguishing plates, into individual arcs, regardless of their original polarity. To guide arcs, originally of differing polarity, into different areas of a consequently not common extinguishing device, is not an object of the invention. A common extinguishing device has the advantage that its entire “extinguishing capacity” is available regardless of the original polarity of the arc. The entire extinguishing device can accordingly be made smaller compared to multiple extinguishing devices for each contact pair.

It is preferably provided that the first arc guide path is so configured that an arc with the first current direction is guided in the direction of the extinguishing device and that the second arc guide path is so configured that an arc with the second current direction is guided in a direction away from the extinguishing device, re-directed and guided back in the direction of the extinguishing device.

Furthermore, it is preferably provided that the extinguishing device is configured as a deionising extinguishing chamber with a plurality of extinguishing plates arranged in parallel.

Furthermore, it is preferably provided that the first arc run path consists of two spreading first guide plates extending from the contact pair and the second arc run path consists of two spreading second guide plates extending from the contact pair. It is particularly preferred that an upper first guide plate and a lower second guide plate each extend from a contact support, the second contact being positioned on the contact support. Furthermore, it is preferably provided that a fixed contact support forms sectionally an upper first guide plate and sectionally a lower second guide plate. It is particularly preferred to provide that the upper first guide plate extends around the contact area and toward the extinguishing device. It is furthermore particularly preferred to provide that at least one guide plate extension for further guiding the arc supplements the upper first guide plate and/or the lower second guide plate.

It is furthermore particularly preferred to provide that the second arc run path has a reversing guide plate, whereby an arc on the second arc run path can be reversed along the reversing guide plate and can be guided from the second contact to the lower second guide plate.

It is furthermore particularly preferred to provide that the first arc run path and the second arc run path run at least sectionally isolated from one another. It is furthermore particularly preferred to provide that the extinguishing device is subdivided into two extinguishing areas by an insulating device. It is furthermore particularly preferred to provide that the insulating device is of comb-shaped construction.

The switching device according to the invention is preferably of single throw design. The invention can, however, be directly applied to double-throw switching devices wherein two contact pairs are provided, each with a first contact and a second contact, forming a double-throw switching arrangement, the second contacts being located on a contact support that can be moved toward the first contacts and each of the second contacts, in the switched-on condition of the switching device, being in contact with one of the first contacts and the contact support electrically interconnecting the two contacts. It is then particularly preferred to provide that the arc guiding assemblies for the two contact pairs are positioned in mirror-image fashion on opposite sides of the contact support. Furthermore, it can then preferably be provided that a plurality of single- or double-throw switching devices are placed side-by-side, the contact supports of the individual switching arrangements being operated from a common switching bridge.

Furthermore, it is provided that the arc guiding arrangements comprises at least one permanent magnet which is arranged between two pole plates, the contact pair being arranged between the pole plates.

The invention will be described in further detail hereafter based on exemplary embodiments, with reference to the drawings. The designs are only exemplary and do not restrict the general concept of the invention.

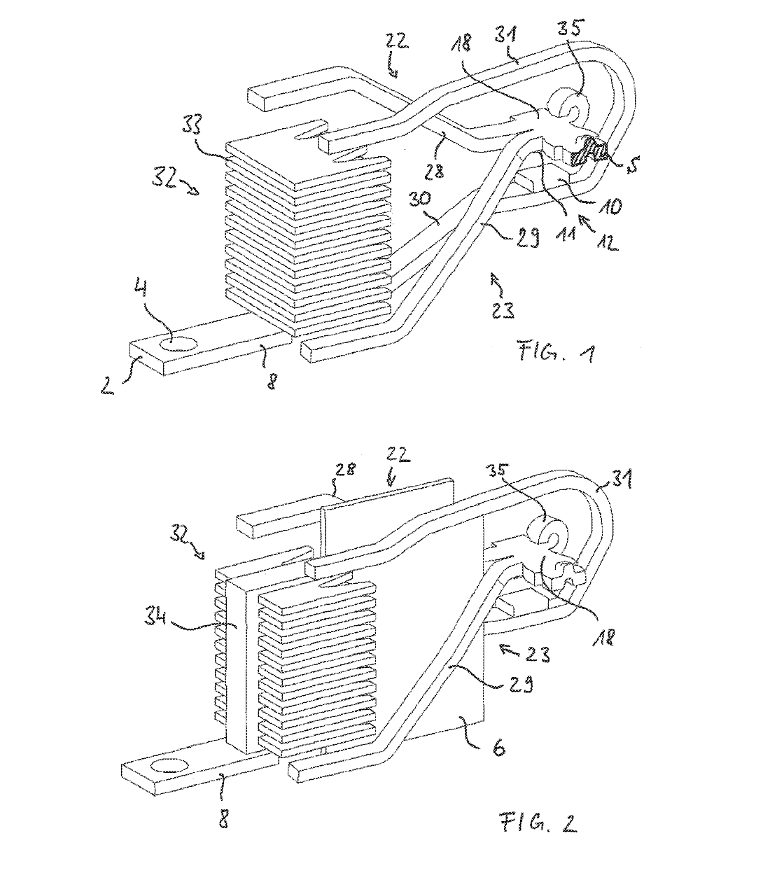

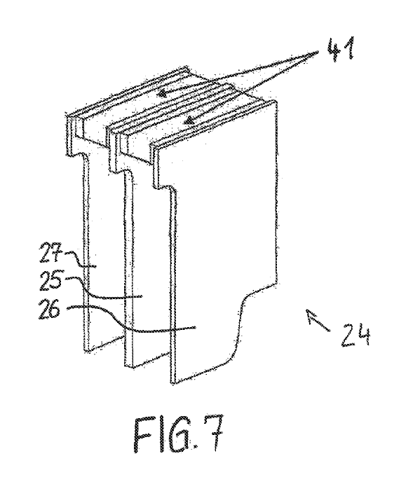

For the sake of clarity, the switching devices shown in FIGS. 1 through 6 are shown only partially and without a housing or magnet arrangement. A single switching path 2 with connection 4 is shown in part. The switching path 2 comprises a fixed contact support 8, which extends toward a contact area 12, where a fixed first contact 10 is positioned which cooperates with a movable second contact 11 on the contact support 18. With the contacts 10, 11 closed, current flows from the fixed contact support 8 into the movable contact support 18. The onward current flow is essentially known to a specialist. In a single-throw switching device, the current flows from the contact support out to a second connection, not shown. The switching device according to the invention actually proves particularly effective with a single throw, as a particularly low-height construction can be attained in this case. In a double-throw switching device, the device shown would be reproduced in mirror image at the cutting plane S. That means that current flows through the contact support 18 to a second contact area, not shown, and, when the contacts are closed, onward into another fixed contact support with a corresponding connection. For the case of a multi-pole switching device, the device described can be multiplied, the contact supports 18 being synchronously switchable for multiple poles, provided that these are fixed to a common switching bridge. With this proviso, the details of the various embodiments will be explained hereafter. An arc driver assembly 24 for generating a magnetic field appears in FIG. 7.

FIG. 1 shows a switching device according to the invention which is suitable for direct current operation. An arc guiding assembly is provided for guiding an arc arising between the first contact 10 and the second contact 11 toward an extinguishing device 32, the arc guiding assembly being subdivided into a first arc guide path 22 and a second arc guide path 23. The first arc guide path 22 is provided for guiding an arc arising between the first contact 10 and the second contact 11 with a first current direction. Accordingly, the second arc guide path is provided for guiding an arc arising between the first contact 10 and the second contact 11 with second current direction opposite to the first current direction. In the process, the second arc guide path 23 performs a reversal of the arc, or a reversal of the current direction in the arc, relative to the essentially homogeneous magnetic field generated by permanent magnets, making it possible for the arc to be guided into a common extinguishing device 32 regardless of the original current flow direction in the arc. The higher mass and surface area of the common extinguishing device 32 compared to two separate extinguishing devices has the advantage of improved heat removal and consequently better extinguishing performance.

The first arc run path 22 consists of two spreading first guide plates 28, 30 extending from the contact pair 12, an upper first guide plate 28 extending outward from the contact support 18 toward the extinguishing device 32 and a lower first guide plate 30 consisting of a section of the fixed contact support 8. The second arc run path 23 also consists of two spreading second guide plates 29, 31 extending from the contact pair 12. A lower second guide plate 29 extends out from the contact support 18 toward the extinguishing device 32, another section of the fixed contact support 8 forming an upper second guide plate 31. Here the upper second guide plate 31 extends around the contact area 12 and onward to the extinguishing device 32. In addition, the second arc run path 23 has a reversing guide plate 35, allowing an arc on the second arc run path 23 to be reverses along the reversing guide plate 35 and guided to the lower second guide plate 29.

Depending on the direction of current flow in the arc, it is either driven directly by the essentially homogeneous magnetic field through the first arc guide path 22 into the extinguishing device 32 and extinguished there, or driven first in the opposite direction and reversed between the upper second guide plate 31 and the reverse guide pate 35 and through the second arc guide path 23 into the same extinguishing device 32 and extinguished there.

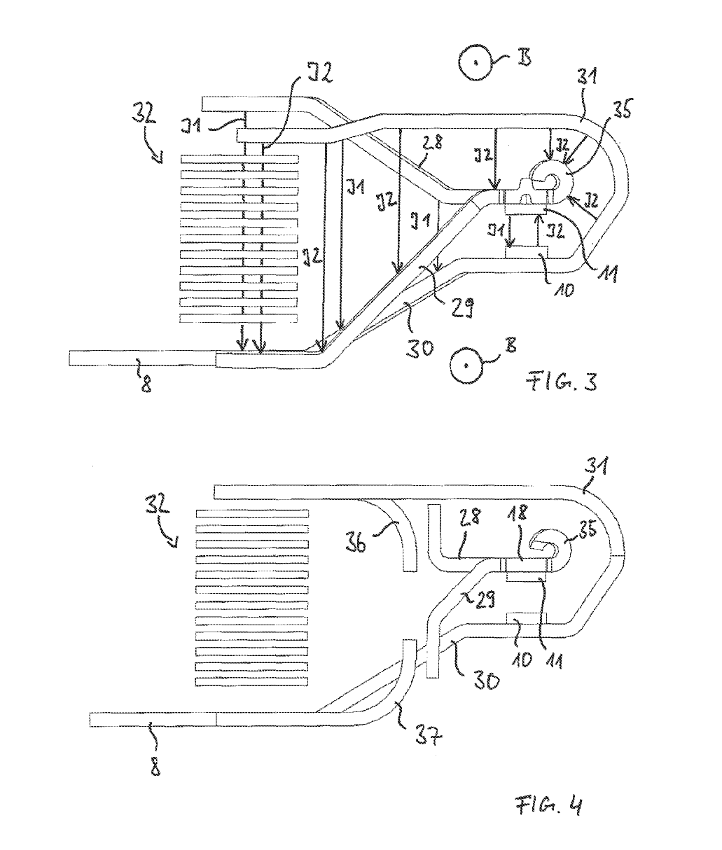

Features of an improved switching device will be described in conjunction with FIG. 2. In order to prevent flashover of the arc from the first arc guide path 22 to parts of the second arc guide path 23 and vice versa, an insulating separating wall 6, particularly a part of the housing, is provided between the first arc guide path 22 and the second arc guide path 23, extending from the contact area 12 up to the extinguishing device 32. As an additional safeguard, a comb-shaped insulator 34 can reach into the extinguishing device 32, whereby the ionized gases generated by the arc are held back and cannot propagate between the extinguishing plates 33.

The driving of arcs having differing current flow directions will be described in more detail with reference to FIG. 3. Between the open contacts 10, 11, arcs are schematically shown for comparison as arrows J1 and J2, the direction of the arrows J1 and J2 being different so as to illustrate the different current flow directions in the arcs. Of course, two arcs with different current directions never occur simultaneously in one switch; the illustration serves only to show the comparison between arc guide paths 22, 23. A homogeneous magnetic field B is drawn in, with field lines extending out of the plane of the drawing. The arcs J1 and J2 are initially driven in different directions. Consequently, arc J1 moves in the direct path into the extinguishing device 32, while the arc J2 is initially reversed until it is turned by about 180 degrees. The arc J2, which after reversal is directed just like the arc J1, is now also driven into the sole extinguishing device 32. In other words, the current flow direction in arc J2 has been reversed relative to the magnetic field B, so that the direction of the Lorentz force acting on the arc is also reversed.

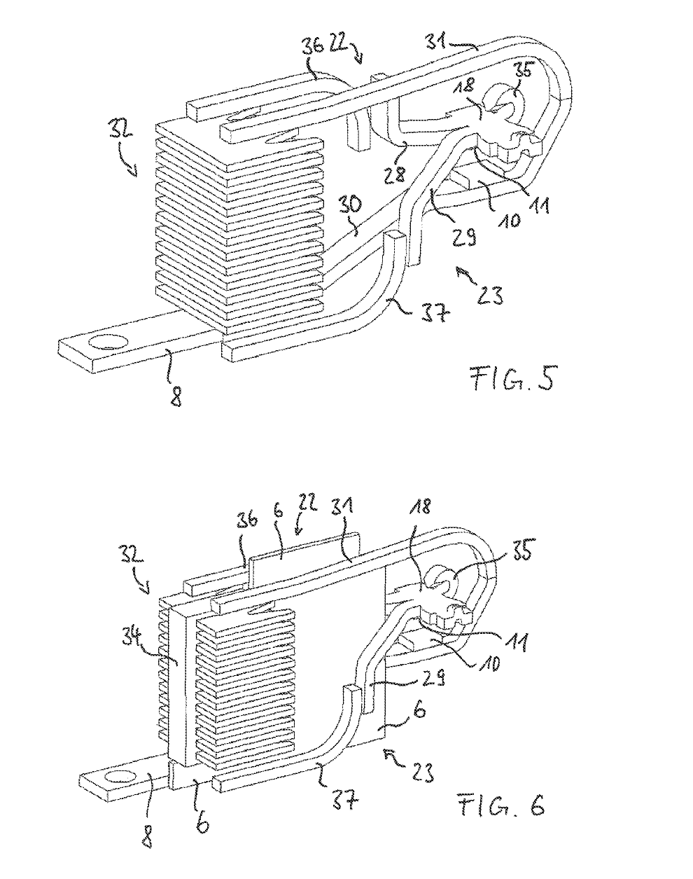

Another preferred embodiment of the switching device according to the invention is shown in FIGS. 4 through 6, the embodiment being advantageously easier to implement in practice. The differences from the previously described embodiments clearly recognizable in FIGS. 4 and 5 related to the arc guiding assembly, namely the upper first guide plate 28 of the first arc guide path 22 and the lower second guide plate 29 of the second arc guide path 23. The guide plates 28, 29 are connected to the movable contact support 18. Making the moving parts less elaborate, smaller and lighter eases the operability and in particular the construction of the switching device. For this reason, the upper first guide plate 28 and the lower second guide plate 29 are shortened; they do not extend all the way to the extinguishing device 32. Instead, they are so angled at their ends that the respective end area of the guide plates 28, 29 run at a constant distance from the extinguishing device 32. Instead, a first guide plate extension 36 and a second guide plate extension 37 are provided, each of which extends up to the extinguishing device 32. The first guide plate extension 36 thus supplements the first arc guide path 22 and the second guide plate extension 37 the second arc guide path 23. As the arc in the angled end areas of the guide plates 28, 29 can no longer follow them, a second arc arises, to with either between the upper first guide plate 28 and the first guide plate extension 36 or between the lower second guide plate 29 and the second guide plate extension 37, depending on which of the arc guide paths 22, 23, the arc occupies. Then either the first guide plate extension 36 or the second guide plate extension 37 is connected with the respective guide plate 28, 29, therefore at the same potential level. The original arc can be guided onward between the first guide plate extension 36 and the lower first guide plate 30 or between the second guide plate extension 37 and the upper second guide plate 31. After the extinguishing of the arc in the extinguishing device 32, the additional arc to the guide plate extension 36, 37 is also extinguished.

The switching device according to FIG. 5 is again shown in FIG. 6 with the separating wall 6 and the comb-shaped insulator 34, where it is also observable that the housing part forming the separating wall 6 is extended below the extinguishing device 32.

In the switching device according to the invention, an arc driver assembly 24 is provided, which is shown by way of example in FIG. 7. The arc driver assembly 24 comprises for example two permanent magnets 41, each arranged between two pole plates 25, 26, 27. Thus three pole plates are provided, namely a middle pole plate 25 between the two permanent magnets 41 and a first exterior pole plate 26 and a second exterior pole plate 27. The permanent magnets 41 can be located for example above the arc guiding arrangement, the pole plates 25, 26, 27 reaching vertically downward and forming the lateral boundaries of the switching chambers. Either the pole plates 25, 26, or the pole plates 26, 27 are arranged in the area of the first contact pairs 12 and they preferably cover the entire area of the two arc guiding arrangements. This arrangement of the permanent magnets 28 and the pole plates 25, 26, 27 ensures that a homogeneous magnetic field is generated between the pole plates 25, 26, 27 running perpendicular to the pole plates, the field lines consequently running transverse to the direction of movement of the contact support 18. Thus the field lines of the magnetic field generated by the arc guide assembly 24 also run transverse to an arc which can form between the first contact 10 and a second contact 11. There is a Lorenz force generated in this manner acting on the arc and driving the arc in a specific direction depending on the direction of the magnetic field and the direction of current of the arc.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

2 Switching path

4 Connection

6 Separating wall, housing part

8 Fixed contact support

10 First contact

11 Second contact

12 Contact pair

18 Contact support

22 First arc guide path

23 Second arc guide path

24 Arc driver assembly

25 Middle pole plate

26 First exterior pole plate

27 Second exterior pole plate

28 Upper first guide plate

29 Lower second guide plate

30 Lower first guide plate

31 Upper second guide plate

32 Extinguishing device

33 Extinguishing plate

34 Comb-shaped insulation

35 Reversing guide plate

36 First guide plate extension

37 Second guide plate extension

41 Permanent magnet

S Section plane

B Magnetic field

J1, J2 Arc, arrows

1. A switching device, suitable for direct current operation, the switching device comprising:
a contact pair including a first contact and a second contact, at least the second contact being movable and the first contact being in contact with the second contact in a switched-on condition of the switching device and out of contact in a switched-off condition of the switching device;
an arc driver assembly configured to generate magnetic field: and
an arc guide arrangement configured to guide an arc arising between the first contact and the second contact toward an extinguishing device,
wherein the arc guide arrangement is subdivided into a first arc guide path and a second arc guide path,
wherein the first arc guide path is configured to guide an arc arising between the first contact and the second contact with a first current direction,
wherein the second arc guide path is configured to guide an arc arising between the first contact and the second contact with a second current direction opposite to the first current direction,
wherein the second arc guide path is configured to reverse the arc, the current, or the arc and the current,
the arc being guided into a common extinguishing device regardless of the original current flow direction in the arc.

2. The switching device of claim 1, wherein the first arc guiding arrangement is configured such that the arc with a first current direction is guided to the extinguishing device, and
wherein the second arc guiding arrangement is configured such that the arc with a second current direction is guided in a direction away from the extinguishing device, reversed, and guided back in a direction toward the extinguishing device.

3. The switching device of claim 1, wherein the extinguishing device is constructed as a deionizing extinguishing chamber including a multitude of extinguishing plates arranged in parallel.

4. The switching device of claim 1 wherein the first arc guide path includes two spreading guide plates extending from the contact pair, and
wherein the second arc guide path includes two spreading guide plates extending from the contact pair.

5. The switching device of claim 4, further comprising:
an upper first guide plate and a lower first guide plate,
wherein the upper first guide plate and the lower first guide plate each extend outward from a movable contact support, and
wherein the second contact is located on the movable contact support

6. The switching device of claim 5, further comprising:
guide plate extension configured for onward guidance of the arc,
wherein the guide plate extension supplements the upper first guide plate, the lower second guide plate, or both.

7. The switching device of claim 4 further comprising:
a fixed contact support,
wherein the fixed contact support sectionally constitutes a lower first guide plate and sectionally constitutes an upper second guide plate.

8. The switching device of claim 7, wherein the upper second guide plate extends around a contact area and toward the extinguishing device.

9. The switching device of claim 1, second arc guide path includes a reversing guide plate,
wherein the second arc guide path is configured to allow an arc on the second arc guide path to be reversed along the reversing guide plate and guided front the second contact to the lower second guide plate.

10. The switching device of claim 1 wherein the first arc guide path and the second arc guide path run at least sectionally isolated from one another.

11. The switching device wherein wherein the extinguishing device is subdivided by an isolating device into two extinguishing areas.

12. The switching device of claim 11, wherein the isolation device is of comb-shaped construction.

13. The switching device of claim 1 comprising at least two switches arranged next to each other,
wherein contact supports of individual switching arrangements are actuated by a common switching bridge.

14. The switching device of claim 1, wherein the arc guiding arrangement includes a permanent magnet,
wherein the permanent magnet is arranged between two pole plates, and
wherein the contact pair is arranged between the two pole plates.

15. The switching device of claim 1, wherein the extinguishing device includes a deionizing extinguishing chamber including a multitude of extinguishing plates arranged in parallel.

16. The switching device of claim 1, wherein the first arc run path includes two spreading guide plates extending from the contact pair, and
wherein the second arc run path includes two spreading guide plates extending from the contact pair.
